(19) United States
(12) Patent Application Publication
(10) Pub. No.: US 2016/0161620 A1
(43) Pub. Date: Jun. 9, 2016

(54) SYSTEM AND METHOD FOR ESTIMATING REPEATABILITY USING BASE DATA

(71) Applicant: CGG SERVICES SA, Massy (FR)

(72) Inventors: Henning Hoeber, East Grinstead (GB); Celine LaCombe, Massy Cedex (FR)

(21) Appl. No.: 14/900,401

(22) PCT Filed: Jun. 27, 2014
(86) PCT No.: PCT/EP2014/063752

§ 371 Date: Dec. 21, 2015

Related U.S. Application Data
(60) Provisional application No. 61/840,780, filed on Jun. 28, 2013.

(51) Int. Cl. G01V 1/30; G01V 1/00

(52) U.S. Cl. CPC G01V 1/308; G01V 1/003; G01V 2210/612

(57) ABSTRACT

In accordance with some embodiments of the present disclosure, systems and methods for estimating repeatability using base data are disclosed. The method includes obtaining data corresponding to a survey of an exploration area, where the data includes a plurality of traces associated with the exploration area, and an acquisition metric associated with each trace of the plurality of traces. The method also includes grouping the plurality of traces into a plurality of bins, the plurality of bins based on the acquisition metrics. The method further includes calculating an acquisition repeatability metric for each pair of traces in each bin based on the acquisition metrics, and calculating a seismic repeatability metric for each pair of traces in each bin.

### CROSS-REFERENCE TO RELATED APPLICATIONS

The present application claims the benefit of priority under 35 U.S.C. §119 from U.S. Provisional Patent Application Ser. No. 61/840,780, filed on Jun. 28, 2013, which is incorporated by reference in its entirety for all purposes.

### TECHNICAL FIELD

The present disclosure relates generally to seismic exploration tools and processes and, more particularly, to systems and methods for estimating repeatability using base data.

### BACKGROUND

In the oil and gas industry, geophysical survey techniques are commonly used to aid in the search for and evaluation of subterranean hydrocarbon or other mineral deposits. Generally, a seismic energy source, or “source,” generates a seismic signal that propagates into the earth and is partially reflected by subsurface seismic interfaces between underground formations having different acoustic impedances. Reflections are recorded by seismic detectors, or “receivers,” located at or near the surface of the earth, in a body of water, or at known depths in boreholes, and the resulting seismic data can be processed to yield information relating to the location and physical properties of the subsurface formations. Seismic data acquisition and processing generates a profile, or image, of the geophysical structure under the earth's surface. While this profile does not necessarily provide an accurate location for oil and gas reservoirs, it suggests, to those trained in the field, the presence or absence of them.

A seismic signal is emitted in the form of a wave that is reflected off interfaces between geological layers. When the wave encounters an interface between different media in the earth's subsurface a portion of the wave is reflected back to the earth's surface while the remainder of the wave is refracted through the interface. The reflected waves are received by an array of geophones, or receivers, located at the earth's surface, which convert the displacement of the ground resulting from the propagation of the waves into an electrical signal recorded by means of recording equipment. The receivers typically record data during the source's sweep interval and during a subsequent “listening” interval. The receivers record the time at which each reflected wave is received. The travel time from source to receiver, along with the velocity of the source wave, can be used to reconstruct the path of the waves to create an image of the subsurface.

The receivers detect the reflected signals and record them in the form of a seismic trace or data. Typically, one trace is recorded per receiver, per survey. Traces from receivers in an array are then compiled to complete the survey. Traces are processed to present the data in suitable form for use by geophysicists for determining the properties and structures of subterranean earth formations. A large amount of data may be recorded by the receivers and the recorded signals may be subjected to signal processing to improve the quality of the data before the data is ready for interpretation. The recorded seismic data may be processed to yield information relating to the location of the subsurface reflectors and the physical properties of the subsurface formations. That information is then used to generate an image of the subsurface. In interpreting or processing data recorded in seismic traces, it is useful if the traces are evenly spaced and sufficiently close together in order to create repeatable, linear data.

Two types of seismic exploration, continuous seismic monitoring and 4D seismic monitoring, involve multiple sources and receivers that may be used for an extended period of time. In continuous seismic monitoring, sources and receivers may continually operate for months or years to monitor changes in a reservoir or other subsurface formation. In 4D seismic monitoring, also called “time-lapse monitoring,” sources and receivers may be used to repeat a seismic survey on or more times separated by a time interval. Each survey can be performed hours, days, weeks, or months apart. 4D seismic monitoring also monitors changes in a reservoir or other subsurface formation.

In a typical continuous seismic monitoring or 4D seismic monitoring survey, a first survey is performed and serves as the baseline survey, often referred to as a “base” or “base survey.” Follow-on surveys—which may be referred to as “monitors,” “monitor surveys,” or “repeat surveys”—are then performed. Surveys may be separated by a fixed time interval, or may be repeated at irregular intervals. The differences, often referred to as “4D differences,” between a base and monitors, or between different monitors, can be compared to determine changes in subsurface layers or in a target reservoir. Such a difference between a base and a monitor, or a difference between monitors, can be caused by changes in the earth's subsurface, by changes in source or receiver equipment characteristics, or by changes in source or receiver positioning.

Typically, 4D seismic monitor surveys attempt to repeat a base survey as closely as possible in order to compute an accurate difference image. Ideally, the sources and receivers remain the same and are placed in the same location in each survey to remove any data variability due to equipment characteristics or location. The locations of sources of receivers may be measured with location service technologies, such as global positioning systems (GPS). However, due to a variety of factors (e.g., navigational imprecision, human error, inadequate location information, environmental effects), the sources or receivers may not be placed in the same locations. Instead, the location of a receiver or source in a monitor may vary from the location of a receiver or a source in the base or in another monitor.

When performing 4D seismic acquisition, a repeatability analysis is typically performed. One goal of the repeatability analysis is to analyze the impact of variations in acquisition properties between a base and a monitor or between different monitors.

Alternatively, a repeatability analysis may be used to define acquisition repeatability constraints or variation tolerances when planning the acquisition of monitor and repeat surveys. For example, a repeatability analysis may assist in determining maximum acceptable errors in source or receiver positioning in a monitor. Additionally, a repeatability analysis may assist in evaluating the impact that positions errors may have on the resolution of a 4D seismic image. Typically, repeatability analyses include a comparison of a seismic repeatability metric and an acquisition repeatability metric.

For example, a seismic repeatability metric may be determined using normalized root-mean-squared (NRMS) analysis. NRMS is typically calculated by determining the difference between values observed for a base and a monitor and normalized by dividing by the average of the base and monitor values. Repeatability is typically evaluated by two different methods: modeling and using cross-variograms. Modeling can be accomplished through many different methods, including finite difference, ray-tracing, or inverted data (sparse reflectivity). Modeling can be used to create synthetic data using real and theoretical geometries for a base and a monitor respectively. Repeatability maps (usually NRMS maps) can be obtained from the synthetic data, either on stacks or on offset bins. However, when using modeling, the level of repeatability estimated for the synthetic data may be greater than the actual data because some causes of non-repeatability, or error, may not be included in the modeling (for example, noise, source variation). Thus, the model may not accurately predict the repeatability of an actual monitor.

A second method for evaluating repeatability is using cross-variograms. To create a cross-variogram, traces in a base and traces in a monitor are compared in terms of seismic repeatability metrics and acquisition repeatability metrics, such as NRMS and differences in source-receiver positions, respectively. For example, NRMS may be calculated based on groups of source-receiver pairs with similar source-receiver distances and similar surface locations. A relationship between these two attributes can be derived and analyzed. The relationship may be called a cross-variogram. For this method to be used, a base and a monitor must have been previously acquired. However, requiring both a base and a monitor to estimate repeatability may be cost prohibitive and increase the complexity of the analysis. For example, a monitor may not be available to use for analysis. Further, because a monitor is required, the impact of a position inaccuracy can only be evaluated after the monitor is complete. If position inaccuracy is sufficiently large, it may require reacquisition of a monitor, which may be cost inefficient. Accordingly, it may be useful to identify systems and methods for improving seismic repeatability analysis.

### SUMMARY

In accordance with some embodiments of the present disclosure, a method of evaluating seismic data is disclosed. The method includes obtaining data corresponding to a survey of an exploration area, where the data includes a plurality of traces associated with the exploration area, and an acquisition metric associated with each trace of the plurality of traces. The method also includes grouping the plurality of traces into a plurality of bins, the plurality of bins based on the acquisition metrics. The method further includes calculating an acquisition repeatability metric for each pair of traces in each bin based on the acquisition metrics, and calculating a seismic repeatability metric for each pair of traces in each bin.

In accordance with some embodiments of the present disclosure, a seismic exploration system is disclosed. The seismic exploration system includes a seismic source configured to emit a seismic signal into a subsurface geology, a seismic receiver configured to receive energy, and a unit communicatively coupled to the seismic receiver. The unit is configured to record received energy, and to obtain data corresponding to a survey of an exploration area. The data includes a plurality of traces associated with the exploration area, and an acquisition metric associated with each trace of the plurality of traces. The unit is further configured to group the plurality of traces into a plurality of bins, the plurality of bins based on the acquisition metrics. The unit is additionally configured to calculate an acquisition repeatability metric for each pair of traces in each bin based on the acquisition metrics, and calculate a seismic repeatability metric for each pair of traces in each bin.

In accordance with some embodiments of the present disclosure, a non-transitory computer-readable medium, including computer-executable instructions carried on the computer-readable medium is disclosed. The instructions, when executed, cause a processor to obtain data corresponding to a survey of an exploration area, where the data includes a plurality of traces associated with the exploration area, and an acquisition metric associated with each trace of the plurality of traces. The instructions, when executed, also cause a processor to group the plurality of traces into a plurality of bins, the plurality of bins based on the acquisition metrics. The instructions, when executed, further cause a processor to calculate an acquisition repeatability metric for each pair of traces in each bin based on the acquisition metrics, and calculate a seismic repeatability metric for each pair of traces in each bin.

### BRIEF DESCRIPTION OF THE DRAWINGS

For a more complete understanding of the present disclosure and its features and advantages, reference is now made to the following description, taken in conjunction with the accompanying drawings, in which like reference numbers indicate like features and wherein:

FIG. 1 illustrates a seismic exploration system including a source and a receiver in accordance with some embodiments of the present disclosure;

FIG. 2 illustrates a plot of exemplary seismic repeatability data in accordance with some embodiments of the present disclosure;

FIG. 3 illustrates a flow chart of an example method for estimating repeatability using base data in accordance with some embodiments of the present disclosure;

FIG. 4 illustrates a cross-sectional view of an exemplary marine seismic exploration system configured to produce images of the earth's subsurface geological structure in accordance with some embodiments of the present disclosure; and

FIG. 5 illustrates a cross-sectional view of a system for estimating seismic repeatability in a land environment in accordance with some embodiments of the present disclosure.

### DETAILED DESCRIPTION

Seismic monitoring methods, such as 4D seismic monitoring, utilize multiple surveys over an extended period of time. A high level of repeatability in a seismic survey may result in lower noise in a 4D difference. Before a monitor survey is acquired, it may be desirable to estimate seismic repeatability using a base. An estimate of repeatability using a base may facilitate efficient acquisition of a monitor. According to embodiments of the present disclosure, a repeatability analysis may be performed using base data.

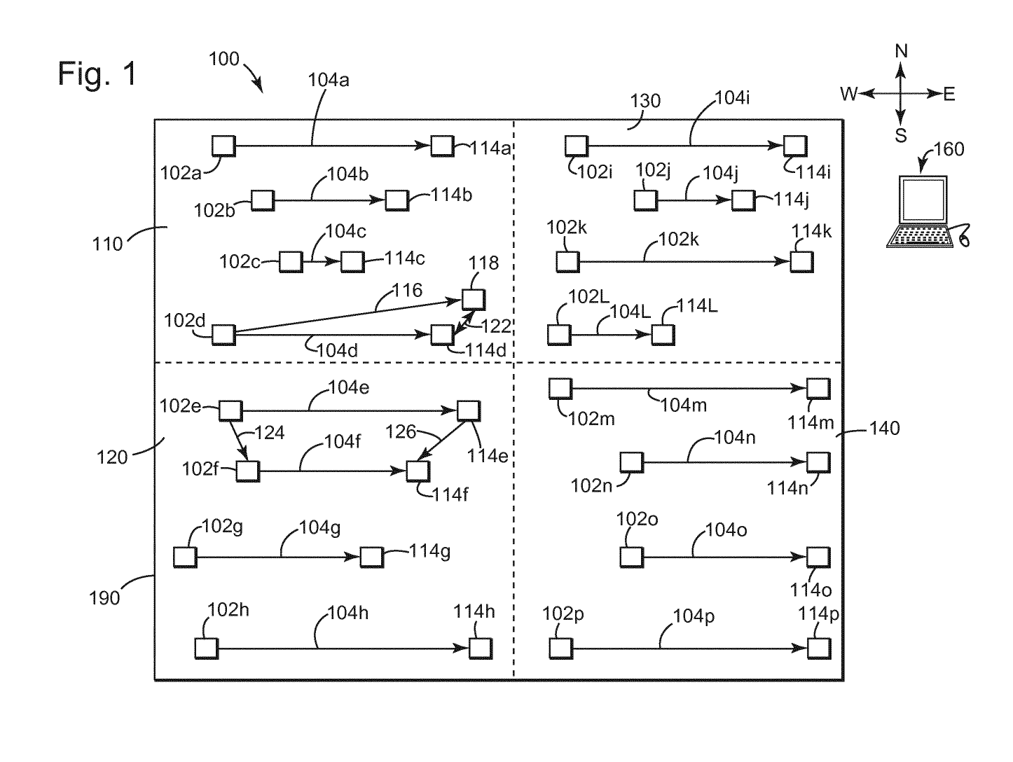

FIG. 1 illustrates a seismic exploration system for use in estimating seismic repeatability in accordance with some embodiments of the present disclosure. System 100 may include one or more seismic energy sources 102a-102p (collectively “sources 102”) and one or more receivers 114a-114p (collectively “receivers 114”), located within predetermined exploration area 190. Although FIG. 1 depicts a single source 102 associated with a single receiver 114, sources 102 may be associated with any suitable number of receivers 114, and receivers 114 may be associated with any suitable number of sources 102. Predetermined exploration area 190 may be any defined area selected for seismic survey or exploration. Acquiring a survey, either a base or a monitor, for predetermined exploration area 190 may include the activation of sources 102 that radiate acoustic wave fields, which expand downwardly through the layers beneath the earth's surface. The seismic wave fields are then partially reflected from the respective layers as a wave front and recorded by receivers 114. In some embodiments, sources 102 generate seismic waves and receivers 114 may receive signals and transmit (to computing system 160) data, in the form of trace.

A trace represents the response of a seismic signal to velocity and density contrasts across interfaces of layers of rock or sediments as energy travels from a source through the subsurface to a receiver. For example, a trace may include data, recorded over a period of time, showing that emitted signals were partially reflected by interfaces between subsurface layers, oil and gas reservoirs, possibly including a target reservoir, or other subsurface structures. When acquiring a monitor, obtaining traces from sources and receivers in the same locations as the sources and receivers used in the base may increase the repeatability of the monitor. Increasing repeatability may allow observation of changes in a reservoir while reducing noise attributable to changes in equipment, such as sources 102 or receivers 114. Specifically, repeatability may be decreased by changes in the locations of sources 102 or receivers 114.

When a monitor is acquired, the locations of the sources and receivers used in the base may not be precisely recreated, rather sources or receivers may be placed in different locations. For example, as shown in FIG. 1, receiver 114d in the base may be misplaced by distance mismatch 122, and located at mismatched receiver 118. Although FIG. 1 depicts a single receiver mismatch, any number of receivers or sources may deviate from their original locations. Using GPS, the magnitude of distance mismatch 122 may be readily determined. However, quantifying noise that distance mismatch 122 contributes to a 4D difference may be costly or time intensive. Further, it may not be possible to quantify the effect of distance mismatch 122 on a 4D difference until after the monitor is completely acquired and the associated data is at least partially processed. However, systems or methods of the present disclosure may be used to estimate repeatability using a base survey. A repeatability analysis may be used to indicate the effect that distance mismatch 122 will have on a 4D difference before monitor acquisition is complete.

Geology may vary spatially across a predetermined exploration area. Accordingly, in some embodiments, repeatability may be estimated for groups of traces that are located close together. In some embodiments, traces may be divided into groups based on the locations of sources 102, receivers 114, and/or the location of the common midpoint of traces associated with sources 102 and receivers 114. For example, based upon the layout of sources 102 and receivers 114 and the size of predetermined exploration area 190, the data included in a base may be subdivided into smaller geometric areas corresponding to subsets of predetermined exploration area 190. As shown in FIG. 1, for example, predetermined exploration area 190 may be subdivided into four geometric areas 110, 120, 130 and 140, however any suitable number of geometric areas may be used. In some embodiments, a fixed size and shape of geometric areas 110, 120, 130 and 140 may be selected. The number of geometric areas may depend on the number on geometric areas required to cover predetermined exploration area 190. In some embodiments, a trace may be assigned to a particular geometric area based on the location of a common midpoint associated with a source 102 and a receiver 114. For example, a trace may be assigned to the geometric area in which the common midpoint is located.

Typically, predetermined exploration area 190 will be divided into multiple geometric areas. However, in some embodiments, predetermined exploration area 190 may not be divided into geometric areas, and repeatability may be estimated across the entire predetermined exploration area 190. In some embodiments, geometric areas may be squares of approximately 25 meters on each side, however, any suitable size of geometric areas may be used. Further, in some embodiments, geometric may be approximately the same size. However, in some embodiments, geometric areas may have different sizes. As depicted in FIG. 1, geometric areas 110, 120, 130 and 140 are rectangular, but any suitable shape may be used in embodiments of the present disclosure.

Within each geometric area 110, 120, 130 and 140, traces from receivers 114 may be grouped into bins based on acquisition metrics. As shown in FIG. 1, source-receiver distances 104a-104p (collectively “source-receiver distances 104”) may be identified for each pair of source 102 and receiver 114. Source-receiver distances 104 may include measurements of distances between sources 102 and receivers 114. In some embodiments, acquisition metrics may also include locations of sources 102, locations of receivers 114, source-receiver distances 104, a location of a common midpoint of a trace, azimuth angles between sources 102 and receivers 114, or any other suitable acquisition metric. In some embodiments, a bin may include traces with similar acquisition metrics. For example, a bin may include traces with associated source-receiver distances 104 within a common fixed range. As shown in FIG. 1, within geometric area 110, because source-receiver distances 104a and 104d are approximately the same length, a pair of traces associated with source 102a and receiver 114a and source 102d and receiver 114d may be allocated to a particular bins. Because source-receiver distances 104b and 104c different lengths, depending on the ranges of the bins, a pair of traces associated with source 102b and receiver 114b and source 102c and receiver 114c may be allocated to a bin including larger source-receiver distances 104. Bins may be assigned equal ranges of acquisition metrics, or bins may have irregular or variable sizes, such as, for example, linearly increasing bin sizes as acquisition metrics increase.

In some embodiments, based upon acquisition metrics, an acquisition repeatability metric, such as total source-receiver displacement, may be calculated. Total source-receiver displacement can be calculated based on acquisition metrics associated with a trace, such as the locations of sources 102 and receivers 114. For a particular pair of traces, a total source-receiver displacement may be calculated by summing the distance between the sources associated with the two traces and the distance between the receivers associated with the two traces. For example, as shown in FIG. 1, total source-receiver displacement may be calculated for traces associated with source 102e and receiver 114e and a trace associated with source 102f and receiver 114f. Total source-receiver displacement would equal the sum of source offset 124 and receiver offset 126.

In some embodiments, each trace within a bin associated with a particular geometric area can be compared to other traces within the same bin. A comparison may include calculating a seismic repeatability metric. In some embodiments, seismic repeatability metrics are calculated for each pair of traces in a bin. Seismic repeatability metrics may include, for example, NRMS, or any other suitable seismic repeatability metric. NRMS is calculated by determining the differences between pairs of traces and normalize by dividing by the average of observed values for the pairs. In some embodiments, traces within a particular bin associated with a geometric area may also be compared to traces in nearby geometric areas and/or similar bins. For example, when a predetermined exploration area is divided into a grid of geometric areas, traces in a particular bin associated with a geometric area may also be compared to traces in adjacent geometric areas, or geometrics areas within a fixed number of grid cells in any direction, including diagonal. Likewise, in some embodiments, traces within a particular bin may be compared to traces in other similar bins. For example, when traces are grouped into bins having fixed ranges, traces in a bin may also be compared to traces in bins with numerically adjacent ranges, or bins within a fixed number of numerically adjacent ranges.

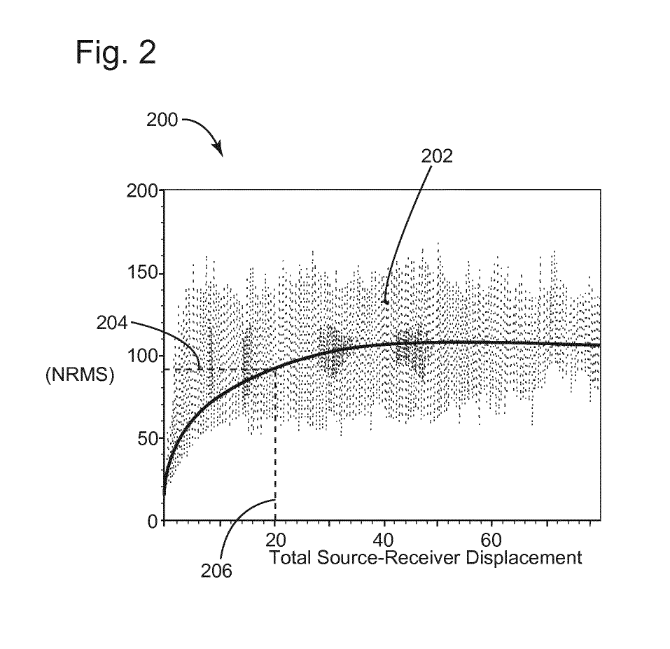

FIG. 2 illustrates a plot of exemplary seismic repeatability data in accordance with some embodiments of the present disclosure. Plot 200 may be referred to as an auto-variogram. An auto-variogram may include an x-axis in acquisition repeatability units, such as total source-receiver displacement, and a y-axis in seismic repeatability units, such as NRMS. For example, plot 200 shows a graph of NRMS data plotted against total source-receiver displacement data. A lower NRMS value indicates better correlation, and that a distance mismatch when acquiring a monitor may have a smaller detrimental impact on a seismic image. Any suitable types of acquisition repeatability data or seismic repeatability data may be used. In some embodiments, a trend line may be calculated based on auto-variogram data. For example, as shown in plot 200, trend 202 may indicate a positive correlation between total source-receiver displacement and NRMS. Different trends may occur for different types of metrics, different geological features, or where different sources of error are present.

Based on an auto-variogram, acquisition repeatability constraints for acquiring a monitor may be identified. For example, a threshold seismic repeatability tolerance value may be selected. For example, in plot 200, tolerance 204 may be selected as the maximum acceptable NRMS value. In some embodiments, tolerance 204 may be selected by a user. Based upon trend 202 and tolerance 204, an acquisition repeatability constraint may be identified. An acquisition repeatability constraint may include a threshold acquisition repeatability metric value. For example, constraint 206 may be selected. Based upon trend 202, traces with a total source-receiver displacement greater than constraint 206 may be expected to generate a NRMS higher than tolerance 204. Accordingly, a total source-receiver displacement greater than constraint 206 may indicate that a monitor should be re-acquired. In contrast, a total source-receiver displacement less than constraint 206 may be expected to generate a NRMS below tolerance 204. Accordingly, a total source-receiver displacement less than constraint 206 may introduce an acceptable level of noise into a seismic image, and may not require reacquisition of a monitor.

In some embodiments, a single auto-variogram is calculated for the entire base. In some embodiments, an auto-variogram is calculated for each geometric area within a predetermined exploration area. Accordingly, auto-variograms may vary spatially within the predetermined exploration area, and may be used to assess the impact on repeatability of laterally varying geology. For example, an auto-variogram can be generated for each geometric area of the predetermined exploration area. Specifically, the impact on repeatability of source or receiver location mismatches in different geometric areas may be estimated by reference to the auto-variogram for that geometric area. In some embodiments, an auto-variogram is calculated for each bin within a geometric area. Accordingly, auto-variograms may vary as seismic acquisitions metrics vary. Specifically, the impact on repeatability of source or receiver location mismatches for different ranges of acquisition metrics may be estimated by reference to the auto-variogram for the corresponding bin. An association of auto-variograms with geometric areas and/or bins may be referred to as a seismic repeatability map. Further, auto-variograms may be used to determine acquisition repeatability constraints for each geometric area and bin, such as a maximum acceptable total source-receiver displacement.

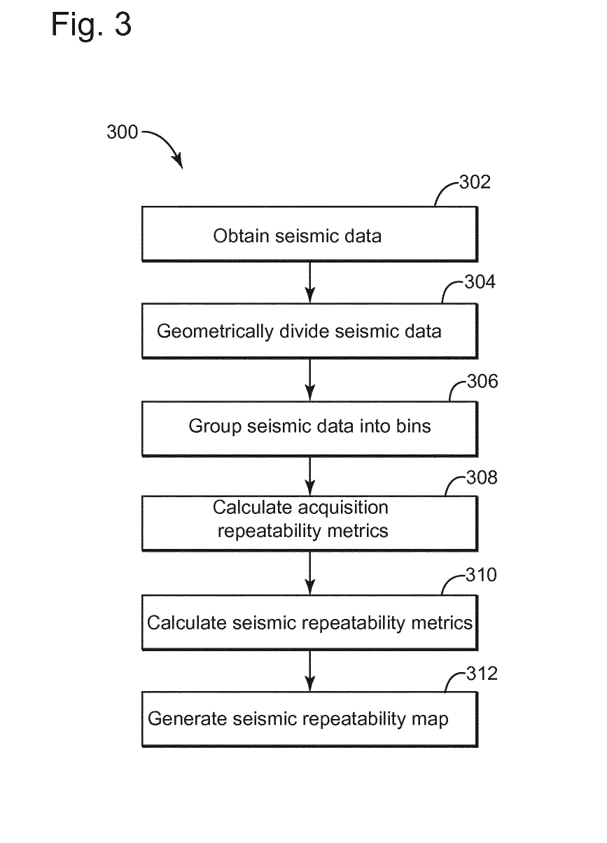

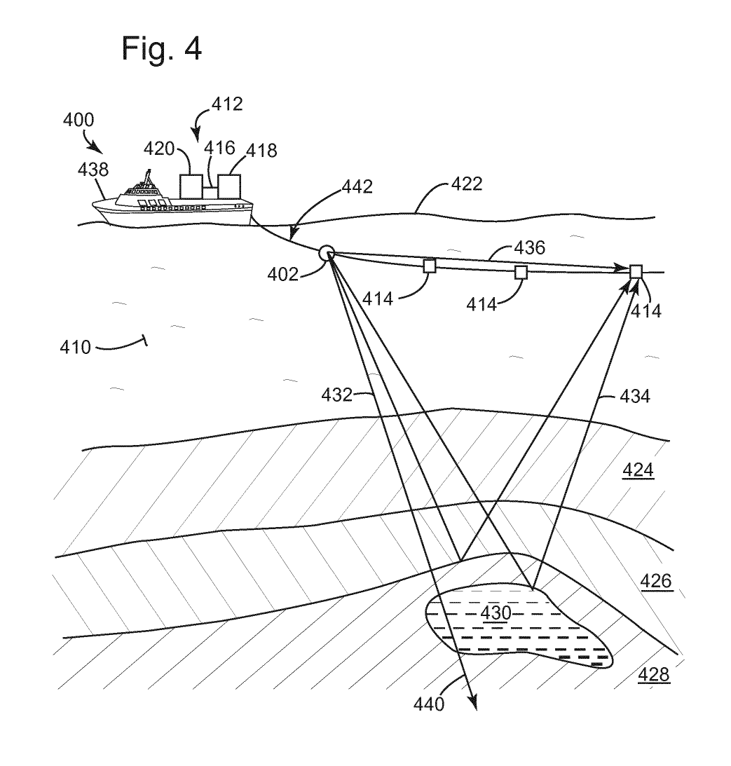

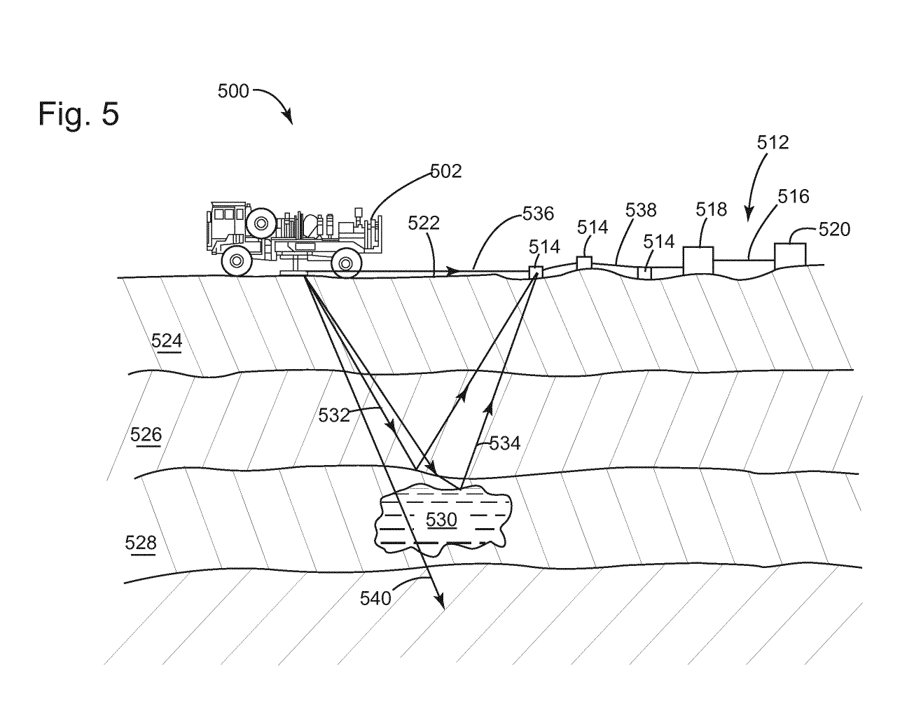

FIG. 3 illustrates a flow chart of example method 300 for estimating repeatability using base data, in accordance with some embodiments of the present disclosure. Estimating repeatability using base data facilitates accurate monitor acquisition. The steps of method 300 may be performed in any suitable manner In some embodiments, the steps of method 300 may be performed by seismic monitoring systems, such as seismic monitoring device 412, discussed in more detail below with reference to FIGS. 4 and 5.

The method 300 begins at step 302, where a seismic monitoring device obtains data from a seismic array used for continuous seismic monitoring or 4D seismic monitoring. The data obtained in step 302 may include traces associated with sources 102 and receivers 114, as shown in FIG. 1 and may constitute a base. Signals may be received by a receiver and recorded by a recording unit, as discussed further with respect to FIGS. 4 and 5. The data may also include an acquisition metric, such as source locations, receiver locations, or source-receiver distances.

In step 304, a seismic monitoring device divides the predetermined exploration area into geometric areas. For example, predetermined exploration area 190 may be divided into rectangles, such as geometric areas 110, 120, 130, and 140, as shown with respect to FIG. 1. In some embodiments, a single geometric area may be used, and repeatability may be estimated for the entire predetermined exploration area 190. In some embodiments, a trace may be assigned to a particular geometric area based on the location of a common midpoint associated with the trace. For example, a trace may be assigned to the geometric area in which the common midpoint is located.

In step 306, for each geometric area, a seismic monitoring device groups the data into bins according to an acquisition metric. For example, the data may be divided into groups of traces with source-receiver distances that fall into a fixed range. For example, in the embodiment shown in FIG. 1, a pair of traces associated with source-receiver pairs, such as source 102a and receiver 114a and source 102d and receiver 114d may be allocated to a bin including larger source-receiver distances, and traces associated with source 102b and receiver 114b and source 102c and receiver 114c may allocated to a bin including smaller source-receiver distances.

In step 308, a seismic monitoring devices calculates acquisition repeatability metrics. In some embodiments. based upon acquisition metrics, acquisition repeatability metrics, such as total source-receiver displacement, may be calculated for each pair of traces in a bin. For example, for a particular pair of traces, a total source-receiver displacement may be calculated by summing the distance between the sources associated with the two traces and the distance between the receivers associated with the two traces. As shown in FIG. 1, total source-receiver displacement for a trace associated with source 102e and receiver 114e and a trace associated with source 102f and receiver 114f would equal the sum of source offset 124 and receiver offset 126.

In step 310, a seismic monitoring device calculates seismic repeatability metrics. Each pair of traces in a bin may be compared to calculate a seismic repeatability metric. For example, as shown in FIG. 2, NRMS values may be calculated. Seismic repeatability metrics may be displayed as an auto-variogram, such as plot 200, shown in FIG. 2. For example, the auto-variogram may be shown as a plot of seismic acquisition data vs. acquisition repeatability data, such as plot 200. A trend line may be identified for the seismic repeatability metric, such as trend 202, shown in FIG. 2. Additionally, a tolerance, such as tolerance 204 may be selected, based on trend 202. Likewise, based on a trend and tolerance, an acquisition repeatability constraint may be identified, such as constraint 206.

In step 312, a seismic monitoring device generates a seismic repeatability map. For example, seismic repeatability data may be associated with each geometric area and/or bin in a predetermined exploration area. Likewise, acquisition repeatability constraints, such as maximum as total source-receiver displacement, may be associated with each geometric area and/or bin. A seismic repeatability map may be used to facilitate acquisition of a monitor.

Once method 300 is complete, the processed data may be used to facilitate monitor acquisition using suitable seismic data processing techniques or used in any other suitable method of using seismic trace data. Method 300 discusses a repeatability analysis using a base. However, during seismic monitoring, a repeatability analysis may also be performed on a monitor. The steps of method 300 may be used to estimate seismic repeatability on any suitable seismic survey data.

The steps of method 300 can be performed by a seismic monitoring device, a user, various computer programs, models, or any combination thereof, configured to simulate, design, or process data from a seismic exploration signal systems, apparatuses, or devices. The programs and models may include instructions stored on a computer-readable medium and operable to perform, when executed, one or more of the steps described above. The computer-readable media can include any system, apparatus, or device configured to store and retrieve programs or instructions such as a hard disk drive, a compact disc, flash memory, or any other suitable device. The programs and models may be configured to direct a processor or other suitable unit to retrieve and execute the instructions from the computer-readable media. Collectively, the user or computer programs and models used to simulate, design, or process data from a seismic exploration systems may be referred to as a “seismic monitoring device.” For example, in some embodiments, a seismic monitoring device may be seismic monitoring device 412, discussed with reference to FIG. 4, or seismic monitoring device 512, discussed with reference to FIG. 5.

Modifications, additions, or omissions may be made to method 300 without departing from the scope of the present disclosure. For example, the order of the steps may be performed in a different manner than that described and some steps may be performed at the same time. Further, more steps may be added or steps may be removed without departing from the scope of the disclosure.

FIG. 4 illustrates a cross-sectional view of an exemplary marine seismic exploration system 400 configured to produce images of the earth's subsurface geological structure in accordance with some embodiments of the present disclosure. The images produced by system 400 allow for the evaluation of subsurface geology. System 400 may include one or more seismic energy sources 402 and one or more receivers 414 which are located within a predetermined exploration area. The exploration area may be any defined area selected for seismic survey or exploration. In the illustrated embodiment, boat 438 tows streamer 442 to which source 402 and receivers 414 are attached. Streamer 442 may include components, such as a network, for transmitting information or data between seismic monitoring device 412, source 402 and receivers 414. Source 402 and receivers 414 may have any suitable structure, configuration, or function described above with respect to FIG. 1. In some embodiments, boat 438 moves along the surface of the water in an exploration are while source 402 emits seismic waves at repeated intervals. Other offshore embodiments may utilize receivers 414 that are not attached to boat 438. For example, receivers 414 may be positioned on or below the sea floor.

Survey of the exploration area may include the activation of seismic source 402 that radiates an acoustic wave field that expands downwardly through sea 410 and layers 424, 426, and 428 beneath the earth's surface. The seismic wave field is then partially reflected from the respective layers as a wave front recorded by receivers 414. For example, source 402 generates seismic waves and receivers 414 record rays 432 and 434 reflected by interfaces between subsurface layers 424, 426, and 428, oil and gas reservoirs, such as target reservoir 430, or other subsurface structures. Subsurface layers 424, 426, and 428 may have various densities, thicknesses, or other characteristics. Target reservoir 430 may be separated from surface 422 by sea 410 and multiple layers 424, 426, and 428. As the embodiment depicted in FIG. 4 is exemplary only, there may be more or fewer layers 424, 426, or 428 or target reservoirs 430. Similarly, there may be more or fewer rays 432 and 434. Additionally, some source waves may not be reflected, as illustrated by ray 440.

Seismic energy source 402 may be referred to as an acoustic source, seismic source, energy source, and source 402. In some embodiments, source 402 is located on or proximate to surface 422 of the sea 410 within an exploration area. A particular source 402 may be spaced apart from other similar sources. Source 402 may be operated by a central controller that coordinates the operation of several sources 402. Further, a positioning system, such as a global positioning system (GPS), may be utilized to locate and time-correlate sources 402 and receivers 414. Multiple sources 402 may be used to improve testing efficiency, provide greater azimuthal diversity, improve the signal to noise ratio, or improve spatial sampling. The use of multiple sources 402 may also input a stronger signal into the ground than a single, independent source 402. Sources 102, as discussed in FIG. 1, may be source 402.

Source 402 may comprise any type of seismic device that generates controlled seismic energy used to perform reflection or refraction seismic surveys, such as an air gun, or any other suitable seismic energy source. Source 402 may radiate seismic energy into sea 410 and subsurface formations during a defined interval of time. Source 402 may impart energy through a sweep of multiple frequencies or at a single monofrequency, or through a combination of at least one sweep and at least one monofrequency.

Seismic exploration system 400 may include seismic monitoring device 412 that operates to record reflected energy rays 432, 434, and 436. Seismic monitoring device 412 may include network 416, recording unit 418, and processing unit 420. In some embodiments, seismic monitoring device 412 may be located remotely from source 402 and/or receivers 414. For example, seismic monitoring device 412 may be located on boat 438. In some embodiments, processing unit 420 may be located remotely from an exploration area. Data may be transmitted from recording unit 418 to seismic processing unit 420 using a wireless network, a local area network (LAN), or a wide area network (WAN), such as the Internet, or any other suitable means for transmitting data.

Receivers 414 may be located on, proximate to, or beneath surface 422 of the sea within an exploration area. Receiver 414 may be any type of instrument that is operable to transform seismic energy or vibrations into a voltage signal. For example, receiver 414 may be a vertical, horizontal, or multicomponent geophone or hydrophone, accelerometers, or optical fiber with wire or wireless data transmission, such as a three component (3C) geophone, a 3C accelerometer, or a 3C Digital Sensor Unit (DSU). Multiple receivers 414 may be utilized within an exploration area to provide data related to multiple locations and distances from sources 402. Receivers 414 may be positioned in multiple configurations, such as linear, grid, array, or any other suitable configuration. In some embodiments, receivers 414 may be positioned along one or more streamers 442. Each receiver 414 is typically spaced apart from adjacent receivers 414 in the streamer 442. Spacing between receivers 414 in streamers 442 may be approximately the same preselected distance, or span, or the spacing may vary depending on a particular application, exploration area topology, or any other suitable parameter. For example, receivers 114, from FIG. 1, may be receiver 414.

One or more receivers 414 transmit raw seismic data from reflected seismic energy, via streamer 442 and network 416 to recording unit 418. Recording unit 418 transmits raw seismic data to processing unit 420 via network 416. Processing unit 420 performs seismic data processing on the raw seismic data to prepare the data for interpretation. For example, processing unit 420 may perform the calculation of auto-variogram data, as described in FIG. 1 and FIG. 2, as well as method 300. Although discussed separately, recording unit 418 and processing unit 420 may be configured as separate units or as a single unit. Recording unit 418 or processing unit 420 may include any instrumentality or aggregation of instrumentalities operable to compute, classify, process, transmit, receive, store, display, record, or utilize any form of information, intelligence, or data. For example, recording unit 418 and processing unit 420 may include one or more personal computers, storage devices, servers, or any other suitable device and may vary in size, shape, performance, functionality, and price. Recording unit 418 and processing unit 420 may include random access memory (RAM), one or more processing resources, such as a central processing unit (CPU) or hardware or software control logic, or other types of volatile or non-volatile memory. Additional components of recording unit 418 and processing unit 420 may include one or more disk drives, one or more network ports for communicating with external devices, one or more input/output (I/O) devices, such as a keyboard, a mouse, or a video display. Recording unit 418 or processing unit 420 may be located on boat 438 or any other suitable location.

Network 416 and streamer 442 may be configured to communicatively couple one or more components of seismic monitoring device 412 with any other component of seismic monitoring device 412. For example, network 416 and streamer 442 may communicatively couple receivers 414 with recording unit 418 and processing unit 420. Further, network 414 and streamer 442 may communicatively couple a particular receiver 414 with other receivers 414. Network 416 and streamer 442 may include any type of network that provides communication, such as one or more of a wireless network, a local area network (LAN), or a wide area network (WAN), such as the Internet.

The seismic survey may be repeated at various time intervals to determine changes in target reservoir 430. The time intervals may be months or years apart as discussed by the intervals illustrated in FIG. 1. Data may be collected and organized based on common mid-point location and source-receiver distances, such as the distance between a particular source 402 and a particular receiver 414 and the amount of time it takes for rays 432 and 434 from a source 402 to reach a particular receiver 414. Data collected during a survey by receivers 414 may be reflected in traces that may be gathered, processed, and utilized to generate a model of the subsurface structure or variations of the structure, for example continuous seismic monitoring or 4D seismic monitoring, for example traces 114 as discussed in FIG. 1.

As explained above, systems and methods for estimating seismic repeatability can be applied to seismic imaging systems in a wide variety of survey environments. While FIG. 4 illustrates a seismic imaging system for estimating seismic repeatability in a marine environment, similar systems can be employed in land environments, in transition zones, or in any area in which seismic imaging is performed. For example, FIG. 5 illustrates a cross-sectional view of a system 500 for estimating seismic repeatability in a land environment in accordance with some embodiments of the present disclosure. In the illustrated embodiment, sources 502 and receivers 514 may be located on surface 522 of the earth in an exploration area. Source 502 and receivers 514 may have any suitable structure, configuration, or function described above with respect to FIGS. 1 and 4.

Source 502 may comprise any type of seismic device that generates controlled seismic energy used to perform reflection or refraction seismic surveys, such as a seismic vibrator, vibroseis, dynamite, an air gun, a thumper truck, or any other suitable seismic energy source. Source 502 may radiate seismic energy into surface 522 and subsurface formations during a defined interval of time. Source 502 may impart energy through a sweep of multiple frequencies or at a single monofrequency, or through a combination of at least one sweep and at least one monofrequency.

Receivers 514 may be located on, proximate to, or beneath surface 422 of the sea within an exploration area. Receiver 514 may be any type of instrument that is operable to transform seismic energy or vibrations into a voltage signal. For example, receiver 514 may be a vertical, horizontal, or multicomponent geophone, accelerometers, or optical fiber with wire or wireless data transmission, such as a three component (3C) geophone, a 3C accelerometer, or a 3C Digital Sensor Unit (DSU). Multiple receivers 514 may be utilized within an exploration area to provide data related to multiple locations and distances from sources 502. Receivers 514 may be positioned in multiple configurations, such as linear, grid, array, or any other suitable configuration. In some embodiments, receivers 514 may be positioned along one or more strings. Each receiver 514 is typically spaced apart from adjacent receivers 414 in the string. Spacing between receivers 514 in a string may be approximately the same preselected distance, or span, or the spacing may vary depending on a particular application, exploration area topology, or any other suitable parameter. For example, receivers 114, from FIG. 1, may be receiver 514.

Survey of the exploration area may include the activation of seismic source 502 that radiates an acoustic wave field that expands downwardly layers 524, 526, and 528 beneath the earth's surface. The seismic wave field is then partially reflected from the respective layers as a wave front recorded by receivers 514. For example, source 502 generates seismic waves and receivers 514 record rays 532 and 534 reflected by interfaces between subsurface layers 524, 526, and 528, oil and gas reservoirs, such as target reservoir 530, or other subsurface structures. Subsurface layers 524, 526, and 528 may have various densities, thicknesses, or other characteristics. Target reservoir 530 may be separated from surface 522 by multiple layers 524, 526, and 528. As the embodiment depicted in FIG. 5 is exemplary only, there may be more or fewer layers 524, 526, or 528 or target reservoirs 530. Similarly, there may be more or fewer rays 532 and 534. Additionally, some source waves may not be reflected, as illustrated by ray 540.

Seismic monitoring device 512 may be similar to seismic monitoring device 412, discussed above with reference to FIG. 4. For example, network 516 and may communicatively couple receivers 514 with recording unit 518 and processing unit 520. Recording unit 518 transmits raw seismic data to processing unit 520 via network 516. Processing unit 520 performs seismic data processing on the raw seismic data to prepare the data for interpretation. For example, processing unit 520 may perform the calculation of auto-variogram data, as described in FIG. 1 and FIG. 2, as well as method 300. In some embodiments, processing unit 520 may be located remotely from an exploration area. Data may be transmitted from recording unit 418 to processing unit 420 using a wireless network, a local area network (LAN), or a wide area network (WAN), such as the Internet, or any other suitable means for transmitting data.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. For example, the signals may be any combination of air gun signals, seismic sweeps, and monofrequencies. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. For example, a receiver does not have to be turned on but must be configured to receive reflected energy.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described. The computer processor may serve as a seismic monitoring device as described in method 300 in FIG. 3.

Embodiments of the disclosure may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a tangible computer-readable storage medium or any type of media suitable for storing electronic instructions, and coupled to a computer system bus. Furthermore, any computing systems referred to in the specification may include a single processor or may be architectures employing multiple processor designs for increased computing capability. For example, the seismic monitoring device described in method 300 with respect to FIG. 3 may be stored in tangible computer-readable storage media.

Although the present disclosure has been described with several embodiments, a myriad of changes, variations, alterations, transformations, and modifications may be suggested to one skilled in the art, and it is intended that the present disclosure encompass such changes, variations, alterations, transformations, and modifications as fall within the scope of the appended claims. Moreover, while the present disclosure has been described with respect to various embodiments, it is fully expected that the teachings of the present disclosure may be combined in a single embodiment as appropriate. Instead, the scope of the disclosure is defined by the appended claims.

What is claimed is:

1. A method of processing seismic data, comprising:
obtaining data corresponding to a survey of an exploration area, where the data includes:
a plurality of traces associated with the exploration area; and
an acquisition metric associated with each trace of the plurality of traces;
grouping the plurality of traces into a plurality of bins, the plurality of bins based on the acquisition metrics;
calculating an acquisition repeatability metric for each pair of traces in each bin based on the acquisition metrics; and
calculating a seismic repeatability metric for each pair of traces in each bin.

2. The method of claim 1, wherein:
the seismic repeatability metric is normalized root mean square (NRMS); and
the acquisition repeatability metric is total source-receiver displacement.

3. The method of claim 1, further comprising subdividing the exploration area into a plurality of geometric areas; and
wherein the plurality of bins is further based on the plurality of geometric areas.

4. The method of claim 3, wherein calculating a seismic repeatability metric comprises calculating a seismic repeatability metric for each geometric area.

5. The method of claim 4, further comprising generating a seismic repeatability map, wherein generating the seismic repeatability map comprises associating the seismic repeatability metrics with the geometric areas.

6. The method of claim 1, wherein calculating a seismic repeatability metric for each bin further comprises selecting an seismic repeatability tolerance for each geometric area.

7. The method of claim 6, wherein calculating a seismic repeatability metric for each bin further comprises identifying an acquisition repeatability constraint based upon the seismic repeatability tolerance.

8. A seismic exploration system comprising:
a seismic source configured to emit a seismic signal into a subsurface geology;
a seismic receiver configured to receive energy; and
a unit configured to record the received energy; the unit further configured to:
obtain data corresponding to a survey of an exploration area, where the data includes:
a plurality of traces associated with the exploration area; and
an acquisition metric associated with each trace of the plurality of traces;
group the plurality of traces into a plurality of bins, the plurality of bins based on the acquisition metrics;
calculate an acquisition repeatability metric for each pair of traces in each bin based on the acquisition metrics; and
calculate a seismic repeatability metric for each pair of traces in each bin.

9. The seismic exploration system of claim 8, wherein:
the seismic repeatability metric is normalized root mean square (NRMS); and
the acquisition repeatability metric is total source-receiver displacement.

10. The seismic exploration system of claim 8, wherein the unit is further configured to subdivide the exploration area into a plurality of geometric areas; and
wherein the plurality of bins is further based on the plurality of geometric areas.

11. The seismic exploration system of claim 10, wherein calculating a seismic repeatability metric comprises calculating a seismic repeatability metric for each bin in each geometric area.

12. The seismic exploration system of claim 11, wherein the unit is further configured to generate a seismic repeatability map, wherein generating the seismic repeatability map comprises associating the seismic repeatability metrics with the geometric areas.

13. The seismic exploration system of claim 8, wherein:
calculating a seismic repeatability metric for each bin further comprises selecting an seismic repeatability tolerance for each geometric location; and
calculating a seismic repeatability metric for each bin further comprises identifying an acquisition repeatability constraint based upon the seismic repeatability tolerance.

14. A non-transitory computer-readable medium, comprising:
computer-executable instructions carried on the computer-readable medium, the instructions, when executed, causing a processor to:
obtain data corresponding to a survey of an exploration area, where the data includes:
a plurality of traces associated with the exploration area; and
an acquisition metric associated with each trace of the plurality of traces;
group the plurality of traces into a plurality of bins, the plurality of bins based on the acquisition metrics;
calculate an acquisition repeatability metric for each pair of traces in each bin based on the acquisition metrics; and
calculate a seismic repeatability metric for each pair of traces in each bin.

15. The non-transitory computer-readable medium of claim 14, wherein:
the seismic repeatability metric is normalized root mean square (NRMS); and
the acquisition repeatability metric is total source-receiver displacement.

16. The non-transitory computer-readable medium of claim 14, wherein the instructions are further configured to cause the processor to subdivide the exploration area into a plurality of geometric areas; and
wherein the plurality of bins is further based on the plurality of geometric areas.

17. The non-transitory computer-readable medium of claim 16, wherein calculating a seismic repeatability metric comprises calculating a seismic repeatability metric for each geometric area.

18. The non-transitory computer-readable medium of claim 17, wherein the instructions are further configured to generate a seismic repeatability map, wherein generating the seismic repeatability map comprises associating the seismic repeatability metrics with the geometric areas.

19. The non-transitory computer-readable medium of claim 14, wherein calculating a seismic repeatability metric for each bin further comprises selecting an seismic repeatability tolerance for each geometric area.

20. The non-transitory computer-readable medium of claim 19, wherein calculating a seismic repeatability metric for each bin further comprises identifying an acquisition repeatability constraint based upon the seismic repeatability tolerance.
